(19) United States
(12) Patent Application Publication
(10) Pub. No.: US 2026/0126026 A1
(43) Pub. Date: May 7, 2026

(54) Self-Cleaning Stator for Water Turbine

(71) Applicant: Cadens, LLC, Sullivan, WI (US)

(72) Inventors: Vito R. Gervasi, Pewaukee, WI (US); Randal Mueller, Sullivan, WI (US); Bruno Patrice-Bernard Lequesne, Fitchburg, WI (US)

(21) Appl. No.: 19/298,270

(22) Filed: Aug. 13, 2025

Related U.S. Application Data
(60) Provisional application No. 63/686,239, filed on Aug. 23, 2024.
(60) Provisional application No. 63/775,403, filed on Mar. 21, 2025.

(51) Int. Cl. F03B 11/08

(52) U.S. Cl. CPC F03B 11/08; F05B 2260/63

(57) ABSTRACT

A turbine suitable for micro hydro turbine applications provides a stator with a self-cleaning front edge employing one or a combination of a rotating surface and guillotine cutter, the self-cleaning front edge allowing larger upstream gratings for improved net water flow.

### CROSS REFERENCE TO RELATED APPLICATION

This application claims the benefit of U.S. provisional application 63/775,403 filed Mar. 21, 2025, and U.S. provisional application 63/686,239 filed Aug. 23, 2024, both hereby incorporated by reference.

### BACKGROUND OF THE INVENTION

The present invention relates to hydroelectric generators and pumps and in particular to a stator for turbines used in such applications and resistant to fouling from debris such as vegetation and trash.

There is a considerable amount of available, but so far unused, energy at US non-power dams in rivers and streams and at canal drops in man-made water channels. Many of these sites are suitable for small capacity micro hydro systems, typically with 15 feet or less of head and generating 1000 kW or less. In such systems, the water is driven towards a turbine consisting of stationary and/or rotating blades, the turbine shaft being connected to typically an electrical generator. Debris from the waterways can thus float towards the turbine blades, occasionally becoming entangled with the turbine or other related, submerged components such as support structures for radial bearings or shaft sleeves. This is a significant issue for a turbine or propeller of any size operating in any water, be it rivers, seas, or man-made canals and conduits as it reduces the system efficiency, and, in more extreme cases, can stall the turbine. But this is a particular challenge for smaller systems. The modest pressures and water flow at these sites can present a problem from debris such as trash and vegetation such as milfoil, leaves, and twigs, as well as man-made material (plastic bags, for instance) that can collect on the turbine components.

Aside from the turbine itself, the energy-producing unit may include ancillary stationary submerged elements, such as support structures for radial bearings or shaft sleeves. The system can also include a sediment passage intake, with submerged supports, which may also get clogged by debris. In sediment passage intakes, particularly those designed for ecological purposes, a significant challenge arises from the accumulation of natural debris such as leaves, twigs, and other vegetation. This debris can become hung up on the leading edges of intake structures, leading to reduced water flow, decreased efficiency of sediment or fish passage, and in severe cases, complete blockage of the intake. Such blockages can compromise the intended environmental benefits and necessitate costly and frequent manual clearing, especially in remote locations.

Screens or gratings placed upstream from the turbine can be used to block or deflect such debris; however, the necessary small opening size in such gratings, needed to remove threadlike debris that can accumulate on the turbine, can significantly reduce water flow and creates an additional burden in cleaning the grating.

### SUMMARY OF THE INVENTION

The present inventors have recognized that threadlike small debris can often pass cleanly through the turbine allowing the grating size of any upstream filtration to be relatively coarse. This type of debris, however, presents a problem primarily when it drapes over the turbine stator in such a way that it is retained by balanced water pressure on each side of the debris. Accordingly, in one embodiment, the invention destabilizes this balanced debris through the use of a rotating leading-edge which urges the debris into an unbalanced configuration where water pressure removes it from the stator. This rotating edge may be combined or replaced with a mechanism such as a guillotine serving to cut the debris to disrupt the balancing and stabilizing forces of water pressure on the debris.

More specifically, in one embodiment, the invention provides a self-cleaning turbine having a water flow channel along a water flow axis and a stator providing a set of blades engaging water in the water flow channel to provide an axial swirl to the water. A turbine is positioned to rotate about the axis and to receive the water after the stator and has blades to extract rotated energy therefrom. A leading edge of the blades of the stator along the axis provides a rotating surface about a rotational axis crosswise to the water flow axis.

It is thus an object of the invention to provide a mechanism for destabilizing debris trapped on the leading edge of the stator.

The leading edge of the stator may be a rod rotatable about the rotation axis.

It is thus a feature of at least one embodiment of the invention to provide a simple implementation of a moving edge that can be readily fit into a stator blade.

The self-cleaning turbine may include an actuator rotating the leading edge of the blade of the stator about the rotational axis during a first time interval and holding the leading edge of the blade without rotation about the rotational axis during a second time interval. In some cases a controller may control a switching between the first time interval and second time interval according to a measurement of power output, flow conditions in the channel, or other parameters.

It is thus a feature of at least one embodiment of the invention to minimize energy consumption by the cleaning mechanism.

The rod may include a first circumferential portion having a surface roughness less than a second circumferential portion, wherein the first circumferential portion is adapted to allow debris to slide off of the first circumferential portion and the second circumferential portion is adapted to grip debris, and wherein the actuator positions the first circumferential portion at the leading edge of the blade of the stator during the second interval.

It is thus a feature of at least one embodiment of the invention to simultaneously provide a leading edge that promotes a sliding release of debris and that can grip the debris to destabilize the debris that is lodged on the stator edge.

The self-cleaning turbine may further or alternatively include a cutter movable along the leading edge of the blade and providing a knife having a knife edge for engaging and cutting material draped over the leading edge of the blade.

It is thus a feature of at least one embodiment of the invention to provide a method of severing debris that is resistant to destabilization by motion.

The leading edge of the stator blades may provide a notch extending along the rotation axis receiving a portion of the knife edge within the slot to pass under debris draped over the leading edge.

It is thus a feature of at least one embodiment of the invention to promote a cutting and lifting of debris.

These particular objects and advantages may apply to only some embodiments falling within the claims and thus do not define the scope of the invention.

### BRIEF DESCRIPTION OF THE DRAWINGS

FIG. 1 is a simplified side elevational view of a small-scale turbine mounted in a penstock showing, in inset, the turbine stator followed by the turbine;

FIG. 2 is a perspective, fragmentary view of a turbine stator blade showing water flow and a rotating leading edge;

FIG. 3 is a cross-section along line 3-3 of FIG. 2 showing the a rotating surface for removing balanced debris on the leading edge of the stator;

FIG. 4 is a figure similar FIG. 2 showing an alternative guillotine for removing debris from the stator leading edge;

FIG. 5 is a perspective fragmentary view of the knife of the guillotine fitting within a slot in the upper non-rotating edge of the stator blade; and

FIG. 6 is a figure similar to that of FIG. 5 showing a combination guillotine and rotating leading surface of the stator blade.

### DETAILED DESCRIPTION OF THE PREFERRED EMBODIMENT

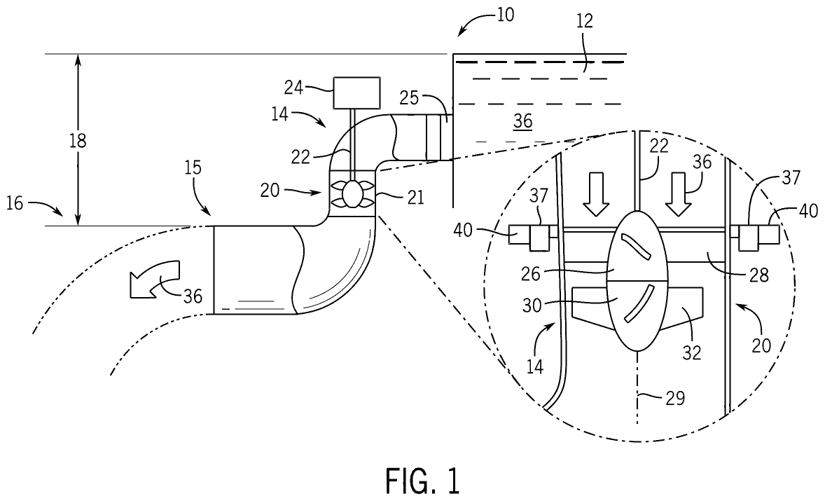

Referring now to FIG. 1, a micro hydroelectric power plant 10 may provide a water reservoir 12 communicating with a penstock 14 through which water may flow to an exit 15. A difference in height between the water in the reservoir 12 and water level 16 at the exit 15 represents the head 18 proportional to potential energy that may be captured by the power plant 10. The penstock 14 holds and directs water 36 past a turbine assembly 20, the latter communicating by means of a rotating shaft 22 with an electrical generator 24 generating electrical power from water flow through the turbine assembly 20.

A grating 25 may be positioned before the penstock 14, for example, where the penstock 14 connects with the reservoir 12. The grating 25 is desirably sized to exclude large debris and fish and may, for example, provide a set of parallel cables or a grid or the like.

The turbine assembly 20 provides an outer cylindrical wall 21 continuous with the walls of the penstock 14 and may include a stator 26 positioned upstream with respect to water 36 flowing along an axis 29. The stator 26 provides radially extending stator blades 28 canted with respect to the axis 29 to impart a swirl to water 36 passing by the stator blades 28. This water 36 is then received by a turbine 30 rotatable about the axis 29 and attached to the shaft 22 to turn the shaft 22 with rotation of the turbine 30. In this regard, the turbine 30 also provides radially extending blades 32 engaging swirling water from the blades 28 of the stator 26 to extract energy from the swirling water.

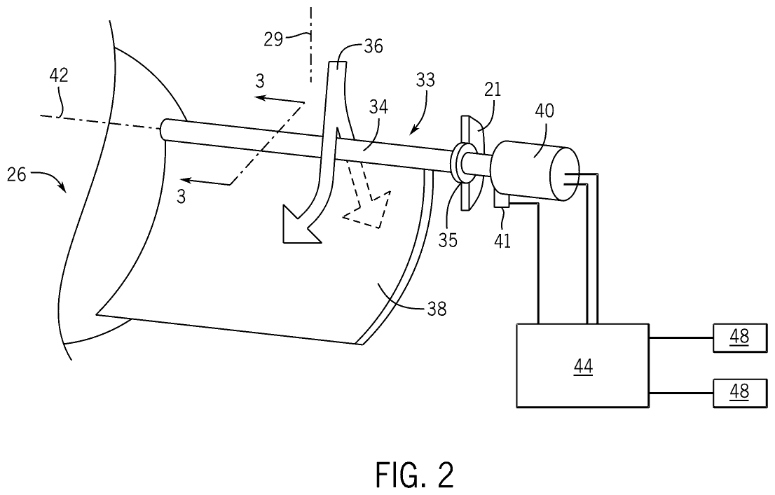

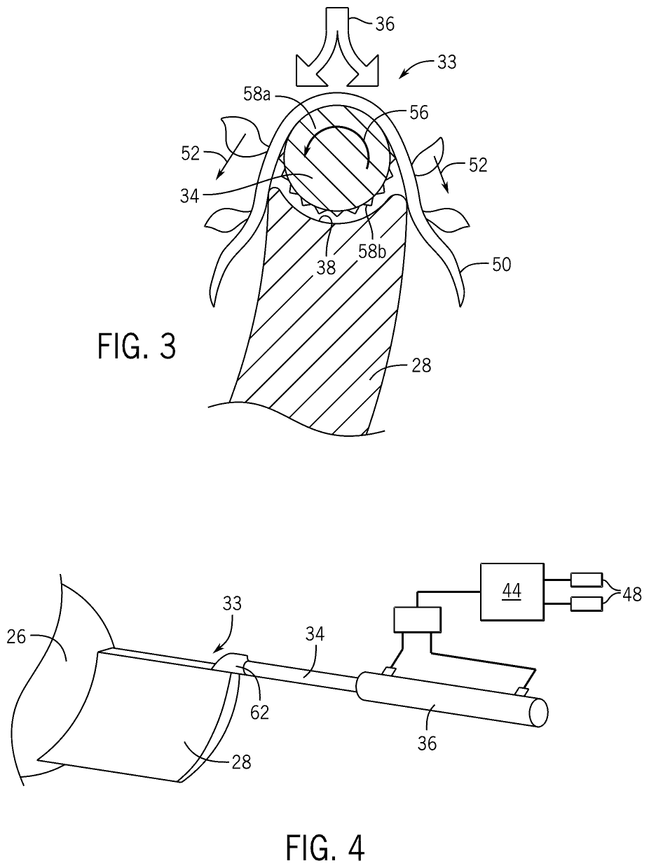

Referring now to FIGS. 2 and 3, a leading edge 33 of each stator blade 28 may be provided by an outer circumference of a cylindrical rod 34 extending along the upper leading edge of the stator blade 28 and crossing the direction of flow of the water 36 so that water 36 divides to pass on either side of the stator blade 28 and passes on either side of the rod 34. The rod 34 may fit within a concave hemicylindrical notch 38 extending along the upper edge of the stator blade 28 below the cylindrical rod 34 minimizing a gap between the rod 34 and the remainder of the stator blade 28. This particular design of rod 34 being cylindrical will only minimally impact the overall form factor of the blade, which always preferably includes a generally round portion at the root of the blade, round and wider than the rest of the blade.

A rotary actuator 40 may connect to the rod 34 through a seal 35 fitting within the wall 21 to rotate the rod 34 about a rotational axis 42 perpendicular to a crossing of the axis 29. The rotary actuator 40, in nonlimiting examples, may be an electric, hydraulic, or pneumatic motor or the like, or may be a passive system deriving energy from water flow itself, for example, through a separate turbine. Multiple rods 34 associated with different stator blades 28 may be driven by separate actuators 40 or a single actuator 40 communicating with the different stator blades 28, for example, using belts, gears, or the like. Although the actuators 40 are shown positioned to the outer sides of the wall 21 of the turbine assembly 20, alternatively the actuators 40 may be positioned within a cowling at the center of the stator 26. This positioning provides for more convenient driving of multiple rods 34 from a single actuator 40, for example, using inter-engaging worm gears on each rod 34 and a central helical gear on the actuator 40 (not shown). The rotary actuator 40 may also include an encoder or limit switch 41 to provide an orientation signal indicating a particular orientation of rotation of the rod 34 as will be discussed below.

The rotary actuator 40 may communicate with a controller 44, for example, an electronic microprocessor or the like, receiving sensor signals from sensors 48 to measure time, output power and/or water flow directly or indirectly as derived from operation of the turbine 30 and its energy output.

In a first embodiment of the invention, the controller 44 assesses time and provides actuation at regular intervals, such as minutes, hours, days, or the like, with such intervals possibly depending on the time of day or night, the season (as these may be indicative of increased flow), or overall operation of the system. The actuation may, for example, rotate the rod by 10 revolutions or until an indication that the debris has been cleared. While intermittent operation is preferred, in order to maximize output, continuous operation is contemplated as well, either year around, for simplicity, or for periods of time extending days or weeks e.g., after a storm when debris accumulation is likely.

Alternatively, various sensors can be employed, by themselves, or in combination. In a first embodiment, these sensors, for instance optical or ultrasound sensors, detect debris directly. In another embodiment, in the exemplary case of an electricity-producing turbine/generator, sensors read the speed of the generator, and/or its output frequency, voltage, and/or output current, thus estimating power output from the generator. This, used in combination with flow measurements, will sense a drop in system efficiency, that is a drop in power output compared to what would be expected from a given flow, thus indicating the likely presence of debris. Flow measurement may be dispensed with, as flow can be estimated from current seasonal and weather conditions, for instance in a riverine application, or, if in a man-made canal, from the overall operation of the canal. In the case of a propeller, the logic is reversed, with the generator being a motor providing energy input to the system, and the speed of the propelled object being one of the possible measured outputs.

The logic in controller 44 can also use a combination of regular cleanings, based on time, with in addition occasional operation based on sensor signals. Further, the controller 44, based on its logic, may actuate a single rod on one of the blades, a few rods on some of the blades, or all the rods fitting the turbine. Such actuation may occur simultaneously (all rods at the same time), or in sequence. Further, rotation of the rod may take place in only one direction, for instance clockwise, or alternate between clockwise and counterclockwise directions, such alternance occurring with every actuation, or every so often, or based on sensed lack of improvement after rotating in a given direction.

In another respect, the controller 44 will stop the rotation of rod 34 so that rotation of the rod 34 stops with the rod 34 in a particular position as will be discussed below. These stop positions of actuator 40 and of rod 34 can be implemented in an open loop fashion, or based on a signal from an encoder or limit switch 41. Further, the actuator may stop after one or a plurality of rotations, according to a predetermined schedule, or based on sensor input.

Referring now specifically to FIG. 3, debris 50 that might otherwise pass freely through the turbine assembly 20 may become lodged on the leading edge of the stator blade 28 when it drapes over both sides of the turbine blade 28 with balanced forces 52 on the debris 50 from water flow on each side of the turbine blade 28. These balancing forces 52 may be unbalanced by rotation 56 of the rod 34 urging the debris 50 to one side and thus off of the stator blade 28. As the debris 50 is displaced, force 52 on the debris 50 on one side of the stator blade 28 increases while the force 52 on the other side of the debris 50 decreases assisting in this removal. The freed debris 50 thus aligns in the water flow, slides off of the stator blade 28, and pass through the turbine blades 32.

Referring still to FIG. 3, improved operation of the rod 34 may be provided by polishing smooth a first circumferential half 58a of the rod 34 and roughening a second opposed circumferential half 58b of the rod 34 mechanically or by the introduction of an abrasive grit such as silicon carbide attached by epoxy or the like to the surface, understanding that surfaces 58a and 58b may encompass each an equal angular span of 180 degrees, or unequal spans such that 58a is wider than 58b, or vice-versa. The rod 34 is normally parked between rotation by the controller 44 with the surface of the first circumferential half 58a facing upward into the water flow to encourage a sliding of debris 50 off of that surface from water flow alone, and also to ensure a smooth flow during operation between cleaning intervals. Periodically, the rod 34 may be rotated, for example, by controller 44 either on a time basis or based on a sensing of debris with the roughened surface 58 now engaging any remaining debris 50 and helping urge that debris 50 off of the leading edge of the stator blade 28.

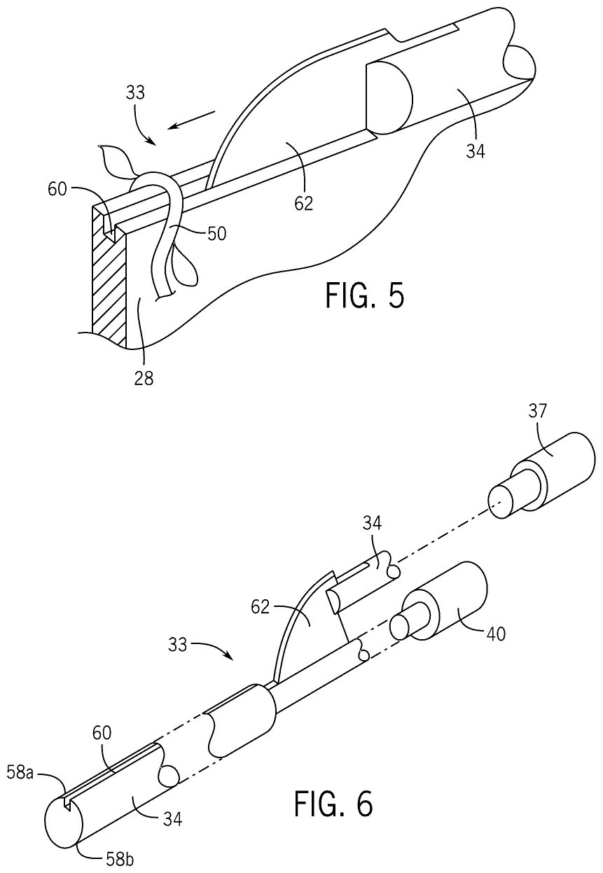

Referring now to FIGS. 4 and 5, in an alternative embodiment, a leading edge 33 of each stator blade 28 may provide for a notch 60 receiving the lower edge of a cutting mechanism such as a knife or a guillotine blade 62 attached to an actuator rod 34 driven by a linear actuator 37. The guillotine blade 62 may be a corrosion resistant stainless steel or ceramic edged blade for durability. Motion of the guillotine blade 62 passing along the extent of the upper edge 33 of the stator blade 28 may thus sever debris 50 draped over the upper edge 33. The linear actuator 37 may be an electric linear actuator, a pneumatic actuator, or the like, operated periodically by the controller 44 again responsive to debris accumulation, water flow, or the like. The linear actuator 37 can be a machine exerting linear motion directly, or a rotating machine coupled with a rotary-to-linear gear. This actuation periodically extends the guillotine blade 62 to clear the upper edge 33 and then retracts the knife blade out of water flow.

Referring now to FIG. 6, a combination of the mechanisms described with respect to FIGS. 2, 3, 4, and 5 may be implemented in which the rod 34 provides on its first circumferential half 58a, a notch 60 that may receive a guillotine blade 62 for clearing debris off of the rod 34 as discussed above. When the guillotine blade 62 is retracted, it may disengage from the notch 60 allowing the rod 34 to rotate to provide for a second basis for debris clearance. Such a system may alternate rotation and knife actuation according to a schedule under the control of the controller 44.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The inventors chose to describe their invention in the context of hydropower production. However, those skilled in the art will recognize that this invention can be applied to both mechanical-to-electric, and electric-to-mechanical systems. That is, any turbine, pump or propeller located in any fluid, where the turbine or pump or propeller is susceptible to be clogged by natural or man-made elements, including sediment passage systems, power plants, pumps, ship propellers, wastewater treatment systems, irrigation canals, and the like. Also, “water” is to be understood as any liquid into which such a system operates. While described in the context of a turbine stator blade, the principles of the rotating leading edge and/or cutter are applicable to, and this disclosure therefore includes, any component within the fluid flow channel (as well as sediment passage intakes and the like) where debris accumulation is problematic, including, but not limited to, support structures for radial bearings, shaft sleeves, or other structural elements that act as an obstruction to flow and on which debris can become lodged.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A self-cleaning fluid flow structure comprising: a fluid flow channel along a fluid flow axis; a submerged component positioned within the fluid flow channel, said submerged component having at least one leading edge that obstructs the fluid flow; and wherein the leading edge of the submerged component provides a rotating surface about a rotational axis crosswise to the fluid flow axis.

2. The self-cleaning fluid flow structure of claim 1 wherein the submerged component is a stator of a turbine, the stator providing a set of blades engaging fluid in the fluid flow channel to provide an axial swirl to the fluid, the turbine having a plurality of blades rotatable about the axis receiving the fluid after the stator.

3. The self-cleaning fluid flow structure of claim 2 wherein the leading edge of the stator is a rod rotatable about the rotational axis.

4. The self-cleaning fluid flow structure of claim 3 further including an actuator rotating the leading edge of the blade of the stator about the rotational axis during a first time interval and to hold the leading edge of the blade without rotation about the rotational axis during a second time interval.

5. The self-cleaning fluid flow structure of claim 4 further including a controller controlling and switching between the first time interval and second time interval according to a measurement of the output of said turbine.

6. The self-cleaning fluid flow structure of claim 4 further including a controller controlling and switching between the first time interval and second time interval according to flow conditions.

7. The self-cleaning fluid flow structure of claim 4 further including a controller controlling and switching between the first time interval and second time interval according to a combination of a measurement of the output of said turbine and of flow conditions.

8. The self-cleaning fluid flow structure of claim 3 wherein the rod includes a first circumferential portion having a surface roughness less than a second circumferential portion, wherein the first circumferential portion is adapted to allow debris to slide off of the first circumferential portion and the second circumferential portion is adapted to grip debris and wherein the actuator positions the first circumferential portion at the leading edge of the blade of the stator during the second interval.

9. The self-cleaning fluid flow structure of claim 1 further including a cutter movable along the leading edge of the blade and providing a knife having a knife edge for engaging and cutting material draped over the leading edge of the blade.

10. The self-cleaning fluid flow structure of claim 9 wherein the leading edge of the blade provides a notch extending along the rotational axis receiving a portion of the knife edge within the notch to pass under debris draped over the leading edge.

11. The self-cleaning fluid flow structure of claim 10 further including a controller for periodically moving the cutter along the leading edge of the blade according to at least one of a measurement of the output of said turbine and flow conditions in the channel.

12. The self-cleaning fluid flow structure of claim 2 further including a grating positioned upstream from the stator to prevent a passage of debris.

13. The self-cleaning fluid flow structure of claim 2 further including an electrical generator rotatably communicating with the turbine.

14. A self-cleaning fluid flow structure comprising:
a fluid flow channel along a fluid flow axis;
a stator providing a set of blades engaging fluid in the fluid flow channel to provide an axial swirl to the fluid;
a turbine rotatable about the axis receiving the fluid after the stator and having blades to extract rotated energy therefrom; and
wherein a leading edge of the blades further includes a cutter movable along the leading edge of the blade and providing a knife having a knife edge for engaging and cutting material draped over the leading edge of the blade.
